(19) United States
(12) Patent Application Publication
(10) Pub. No.: US 2013/0344234 A1
(43) Pub. Date: Dec. 26, 2013

(54) METHOD AND APPARATUS FOR COATING A COMPONENT

(71) Applicant: Marco Systemanalyse und Entwicklung GmbH, Dachau (DE)

(72) Inventor: Martin Reuter, Dachau (DE)

(21) Appl. No.: 13/927,757

(22) Filed: Jun. 26, 2013

(30) Foreign Application Priority Data
Jun. 26, 2012 (DE) 10 2012 210 901.3

(51) Int. Cl. B05B 1/20

(52) U.S. Cl. CPC B05B 1/20
USPC 427/96.1; 239/426

(57) ABSTRACT

In a method for coating a component using a liquid, a liquid curtain is produced with the aid of a fan jet nozzle which has two adjustable nozzle pipes.

The present invention relates to a method for coating a component using a liquid, for example for coating an electronic circuit board with a protective film (coating).

It can generally be advantageous to transfer the coating directly from a nozzle onto the circuit board, with such a direct application having to be carried out in a targeted manner. It must also be possible to coat circuit boards only in part.

It is known from the prior art to use fan jet nozzles whose two nozzle passages are directed toward one another for coating components. However, a spray jet is produced using the nozzles known from the prior art, which is undesirable. In addition, the produced spray jet lies in a plane which extends through the axes of the two nozzle passages, with a spray formation or an atomization of the liquid taking place.

It is the object of the invention to provide a method and an apparatus for coating with which a liquid curtain can be created in a simple manner without a droplet formation taking place.

This object is satisfied by the features of the independent claims.

In accordance with the invention, the outlet surfaces of the nozzle passages are positioned relative to one another such that a liquid curtain is formed centrally between the nozzle passages such that said liquid curtain is oriented substantially at right angles to a plane extending through the axis of the nozzle passages without atomizing the liquid. It has surprisingly been found that a liquid curtain can be produced by a suitable selection of the pressure at which the liquid is led through the nozzle passages, of the size of the outlet openings and of the angle at which the central axes of the nozzle passages intersect which liquid curtain does not extend approximately in parallel or coplanar to that plane in which the central axes of the nozzle passages lie, but rather at right angles thereto. When such a liquid curtain is formed, which cannot be compared with a spray jet, no release of individual droplets takes place. A liquid film is rather formed which is closed until the impact on the component.

Advantageous embodiments of the invention are described in the description, in the drawing and in the dependent claims.

In accordance with a first advantageous embodiment, the outlet surfaces can be oriented relative to one another such that the liquid curtain has curved outer margins at least in a marginal region adjoining its apex, but preferably over its whole extent. The fan jet produced is thus not bounded by straight lines at its outer sides, but rather, due to the surface tension, by outer margins curving toward the jet axis in the jet direction.

In accordance with a further advantageous embodiment, each nozzle passage can be formed in an nozzle pipe which can be adjusted by bending, either manually or with the aid of a manual tool, to position the outlet openings. It is important for the production of the liquid curtain in accordance with the invention that the two part jets exiting the outlet surfaces impact exactly. In order in this respect to allow an orientation and fine adjustment in a simple manner, the nozzle pipes can be manually adjusted, either by hand or with the aid of a manual tool such as pliers, in that the nozzle pipes comprising metal are bent.

In a further advantageous embodiment, the liquid can be led through the nozzle passages at a pressure of approximately 5 to 50 bar, in particular approximately 10 to 30 bar. It can be provided by such a pressure, which is correspondingly low, that the liquid jet does not break down and no droplet formation takes place.

In accordance with a further embodiment of the invention, a fan jet nozzle can be provided which has two nozzle passages having straight central axes, with the outlet surface of each nozzle passage being oriented at right angles to its central axis. It is hereby ensured that the nozzles end with sharp edges at the outlet, which is helpful for producing the liquid curtain in accordance with the invention. In contrast, the success in accordance with the invention cannot easily be achieved by a bore introduced obliquely into a body.

The outlet surfaces of the nozzle passages are preferably circular and can have a diameter which is smaller than approximately 0.5 mm and is in particular smaller than approximately 0.3 mm. A liquid curtain can be produced by a suitable adjustment which stands transverse to the two liquid jets impacting one another. The pressure used is dependent on the viscosity, on the nozzle diameter and on the surface tension and has to be set so that the liquid curtain does not break down or move into atomization.

An exact jet orientation can be achieved after a few tests due to the possibility in accordance with the invention of adjusting the nozzle pipes manually by bending. Such an adjustment is necessary since the jet shape only produces the desired liquid curtain without atomization with the double nozzle in accordance with the invention when the two liquid jets impact one another exactly. A jet from a bore is not, however, always in the bore axis since even very small symmetry defects in the bore or at the end of the bore can deflect the jet.

Since the width of the liquid curtain in accordance with the invention depends on the pressure applied and on the liquid properties such as the viscosity and the surface tension, it is advantageous for a uniform liquid application to know the exact width of the fan jet. This can take place in accordance with a further advantageous embodiment of the invention via a transmission measurement or also via a reflection measurement using a laser beam through which the liquid curtain is moved by moving the nozzle.

The present invention will be described in the following purely by way of example with reference to an advantageous embodiment and to the enclosed drawings. There are shown:

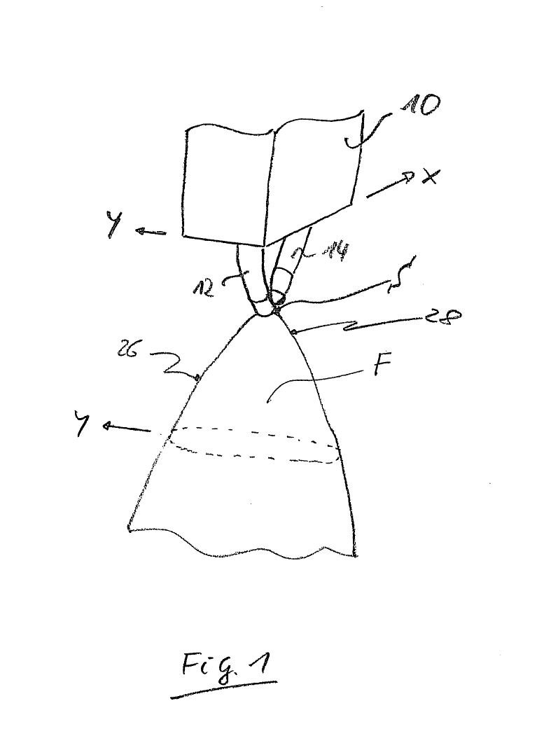

FIG. 1 a greatly simplified perspective representation of a liquid curtain produced by a fan jet nozzle;

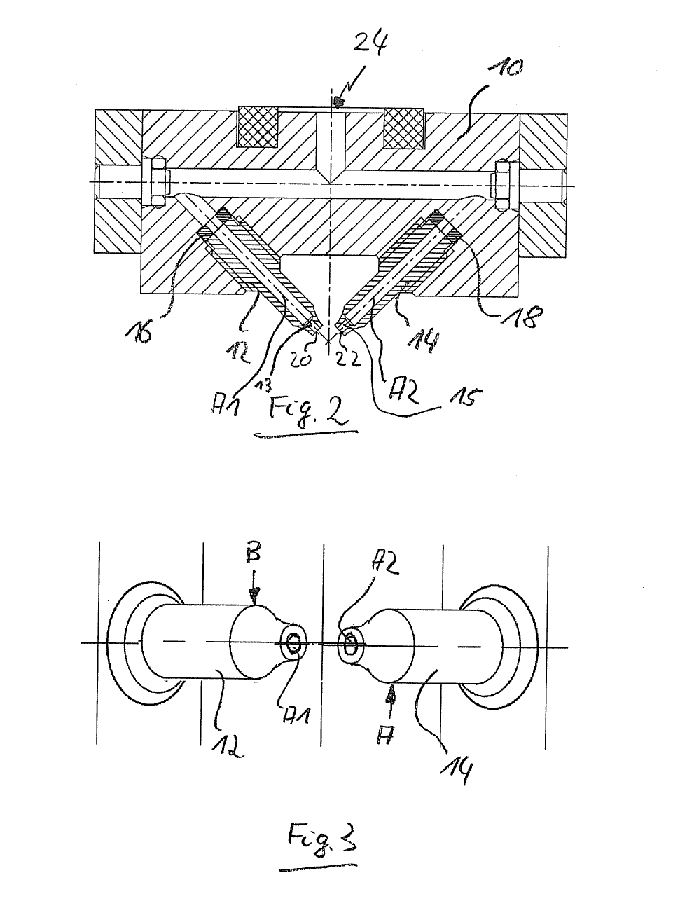

FIG. 2 a section through the fan jet nozzle of FIG. 1; and

FIG. 3 a view from below of the fan jet nozzle of FIGS. 1 and 2.

FIG. 1 schematically shows a base body 10 which is configured as a generally parallelepiped-shaped component, with two nozzle pipes 12 and 14 being inserted into the base body. FIG. 2 shows a section through the fan nozzle of FIG. 1, with it being recognizable that the nozzle pipes 12 and 14 are each screwed into the base body, with a respective O ring 16 and 18 being provided at the base of each nozzle pipe for sealing. Each nozzle pipe has a nozzle passage 13, 15 which opens into an outlet surface 20 and 22 which is oriented at right angles to a central axis A1, A2 of each nozzle pipe. As a comparison of FIG. 2 with FIG. 1 shows, the nozzle passage of each nozzle pipe does not have to extend in a straight line or in a linear fashion over the total length of the nozzle pipe. It is rather sufficient if the central axis A1, A2 of each nozzle passage 13, 15 extends in a straight line directly in front of the outlet surfaces 20, 22 so that a circular-cylindrical volume results in the end section of each nozzle pipe. In the remaining region, the nozzle pipe can, however be or be made curved as is shown in FIG. 1.

FIG. 2 furthermore shows that the nozzle passages of the two nozzle pipes 12 and 14 are connected to one another via bores, with a common inlet opening 24 being provided in the base body via which a pressure connection can take place.

FIG. 3 shows an overview of the fan jet nozzle shown in FIGS. 1 and 2. To orientate the outlet surfaces 20 and 22, the nozzle pipes 12 and 14 can be moved either by hand or using pliers or the like in the direction of the arrows A and B, for example, until the desired liquid curtain is produced.

Since the nozzle pipes are made from metal, the relative position is maintained after such an adjustment.

FIG. 1 shows the formation of the liquid curtain F which has no spray formation or droplet release at all. As can be recognized, the liquid curtain extends approximately at right angles to that plane in which the central axes A1, A2 of the nozzle passages or of the nozzle pipes 12, 14 are located. The liquid curtain produced would therefore extend perpendicular to the plane of the drawing in FIG. 2. This direction is designated by Y in

FIG. 1, whereas the sectional plane shown in FIG. 2 extends in the X direction.

The liquid curtain F recognizable in FIG. 1 has a lenticular cross-section which is shown at high magnification and in dashed lines in FIG. 1 for an improved representation.

It can furthermore be recognized in FIG. 1 that the liquid curtain F has curved outer margins 26, 28 in a marginal region adjoining its apex S and also over the total extent, i.e. the liquid curtain does not have any straight-line outer contour viewed in the jet direction, but rather a curved outer contour.

1. A method for coating a component using a liquid by producing a liquid curtain (F) with the aid of a fan jet nozzle which has two nozzle passages (13, 15) each having straight central axes (A1, A2) and outlet surfaces (20, 22), wherein the liquid is led through the nozzle passages at pressure and their outlet surfaces (20, 22) are positioned relative to one another such that the liquid curtain is formed centrally between the nozzle passages (13, 15) such that it is oriented substantially at right angles to a plane extending through the central axes (A1, A2) of the nozzle passages without atomizing the liquid.

2. The method in accordance with claim 1, wherein the outlet surfaces (20, 22) are oriented relative to one another such that the liquid curtain (F) has curved outer margins (26, 28) at least in a marginal region adjoining its apex (S).

3. The method in accordance with claim 1, wherein each nozzle passage (13, 15) is formed in a nozzle pipe (12, 14) which can be adjusted by bending, manually or with the aid of a manual tool, for positioning the outlet surfaces (20, 22).

4. The method in accordance with claim 1, wherein the liquid is led through the nozzle passages at a pressure of approximately 5 to 50 bar.

5. The method in accordance with claim 1, wherein the liquid is led through the nozzle passages at a pressure of approximately 10-30 bar.

6. A fan jet nozzle which has two nozzle passages (13, 15) each having straight central axes (A1, A2) and outlet surfaces (20, 22), wherein the outlet surface (20, 22) of each nozzle passage is oriented at right angles to its central axis (A1, A2).

7. The fan jet nozzle in accordance with claim 6, configured to carry out a method for coating a component using a liquid by producing a liquid curtain (F) with the aid of the fan jet nozzle, wherein the liquid is led through the nozzle passages at pressure such that the liquid curtain is formed centrally between the nozzle passages (13, 15) such that it is oriented substantially at right angles to a plane extending through the central axes (A1, A2) of the nozzle passages without atomizing the liquid.

8. The fan jet nozzle in accordance with claim 6, wherein the outlet surfaces (20, 22) are oriented relative to one another such that the fan jet (F) has curved outer margins (26, 28) at least in a marginal region adjoining its apex (S).

9. The fan jet nozzle in accordance with claim 6, wherein each nozzle passage (13, 15) is formed in a nozzle pipe (12, 14) which can be adjusted by bending, manually or with the aid of a manual tool, for positioning the outlet surfaces (20, 22).

10. The fan jet nozzle in accordance with claim 6, wherein the outlet surfaces (20, 22) are circular and have a diameter which is smaller than approximately 0.5 mm.

11. The fan jet nozzle in accordance with claim 6, wherein the outlet surfaces (20, 22) are circular and have a diameter which is smaller than approximately 0.3 mm.

12. The fan jet nozzle in accordance with claim 9, wherein the nozzle pipes (12, 14) are inserted into a base body (10).

13. The fan jet nozzle in accordance with claim 10, wherein the nozzle pipes (12, 14) are screwed into the base body (10).

14. The fan jet nozzle in accordance with claim 11, wherein the nozzle pipes (12, 14) are screwed into the base body (10).
